(19) United States
(12) Patent Application Publication
(10) Pub. No.: US 2026/0282061 A1
(43) Pub. Date: Sep. 17, 2026

(54) DEVICES AND METHODS FOR COMMUNICATION

(71) Applicant: NEC Corporation, Tokyo (JP)

(72) Inventors: Lin LIANG, Beijing (CN); Gang WANG, Beijing (CN)

(73) Assignee: NEC Corporation, Tokyo (JP)

(21) Appl. No.: 19/168,621

(22) PCT Filed: Mar. 27, 2023
(86) PCT No.: PCT/CN2023/084199

§ 371 Date: Sep. 24, 2025

(51) Int. Cl. H04W 72/50

(52) U.S. Cl. CPC H04W 72/50

(57) ABSTRACT

Embodiments of the present disclosure provide a solution for query and response in Internet of Things (IoT). In a solution, a communication device comprising: transmitting, to one or more terminal devices, a first command for scheduling a first transmission, the first command indicating a first set of time periods; receiving, from a first terminal device of the one or more terminal devices, first information of the first terminal device during a first time period of the first set of time periods; transmitting, to the first terminal device, a second command for scheduling a second transmission, the second command indicating a second set of time periods different from the first set of time periods; and receiving, from the first terminal device, second information of the first terminal device during a second time period of the second set of time periods.

### FIELDS

Example embodiments of the present disclosure generally relate to the field of communication techniques and in particular, to devices and methods for query and response in Internet of Things (IoT).

### BACKGROUND

In recent years, IoT has attracted much attention in the wireless communication world. More ‘things’ are expected to be interconnected for improving productivity efficiency and increasing comforts of life. Further reduction of size, complexity, and power consumption of IoT devices can enable the deployment of tens or even hundreds of billion IoT devices for various applications and provide added value across the entire value chain. It is impossible to power all the IoT devices by battery that needs to be replaced or recharged manually, which leads to high maintenance cost, serious environmental issues, and even safety hazards for some use cases (e.g., wireless sensor in electric power and petroleum industry).

The automation and digitalization of various industries open numbers of new markets requiring new IoT technologies of supporting batteryless devices with no energy storage capability or devices with energy storage that do not need to be replaced or recharged manually. Thus, ambient IoT (A-IoT) is proposed.

### SUMMARY

In general, embodiments of the present disclosure provide methods, devices and computer storage medium for query and response in IoT.

In a first aspect, there is provided a communication device. The communication device comprises: a processor configured to cause the communication device to: transmit, to one or more terminal devices, a first command for scheduling a first transmission, the first command indicating a first set of time periods; receive, from a first terminal device of the one or more terminal devices, first information of the first terminal device during a first time period of the first set of time periods; transmit, to the first terminal device, a second command for scheduling a second transmission, the second command indicating a second set of time periods different from the first set of time periods; and receive, from the first terminal device, second information of the first terminal device during a second time period of the second set of time periods.

In a second aspect, there is provided a terminal device. The terminal device comprises: a processor configured to cause the terminal device to: receive, from a communication device, a first command for scheduling a first transmission, the first command indicating a first set of time periods; transmit, to the communication device, first information of the terminal device during a first time period of the first set of time periods; receive, from the communication device, a second command for scheduling a second transmission, the second command indicating a second set of time periods different from the first set of time periods; and transmit, to the communication device, second information of the terminal device during a second time period of the second set of time periods.

In a third aspect, there is provided a terminal device. The terminal device comprises: a processor configured to cause the terminal device to: receive, from a communication device, a configuration indicating one or more time periods reserved for transmission to the communication device; and transmit, to the communication device, information of the terminal device during a time period determined based on the configuration.

In a fourth aspect, there is provided a communication device. The communication device comprises: a processor configured to cause the communication device to: transmit, to a terminal device, a configuration indicating one or more time periods reserved for transmission to the communication device; and receive, from the terminal device, information of the terminal device during a first time period determined based on the configuration.

In a fifth aspect, there is provided a terminal device. The terminal device comprises: a processor configured to cause the terminal device to: select at least one time period from a plurality of time periods based on a property of a transmission of information of the terminal device to a communication device; and transmit to the communication device the information of the terminal device during the at least one time period.

In a sixth aspect, there is provided a communication device. The communication device comprises: a processor configured to cause the t communication device to: receive, from a terminal device, information of the terminal device during at least one time period of a plurality of time periods, and wherein the at least one time period is selected from the plurality of time periods based on a property of the transmission of the information.

In a seven aspect, there is provided a communication method performed by a communication device. The method comprises: transmitting, to one or more terminal devices, a first command for scheduling a first transmission, the first command indicating a first set of time periods; receiving, from a first terminal device of the one or more terminal devices, first information of the first terminal device during a first time period of the first set of time periods; transmitting, to the first terminal device, a second command for scheduling a second transmission, the second command indicating a second set of time periods different from the first set of time periods; and receiving, from the first terminal device, second information of the first terminal device during a second time period of the second set of time periods.

In an eighth aspect, there is provided a communication method performed by a terminal device. The method comprises: receiving, from a communication device, a first command for scheduling a first transmission, the first command indicating a first set of time periods; transmitting, to the communication device, first information of the terminal device during a first time period of the first set of time periods; receiving, from the communication device, a second command for scheduling a second transmission, the second command indicating a second set of time periods different from the first set of time periods; and transmitting, to the communication device, second information of the terminal device during a second time period of the second set of time periods.

In a ninth aspect, there is provided a communication method performed by a terminal device. The method comprises: receiving, from a communication device, a configuration indicating one or more time periods reserved for transmission to the communication device; and transmitting, to the communication device, information of the terminal device during a time period determined based on the configuration.

In a tenth aspect, there is provided a communication method performed by a communication device. The method comprises: transmitting, to a terminal device, a configuration indicating one or more time periods reserved for transmission to the communication device; and receiving, from the terminal device, information of the terminal device during a first time period determined based on the configuration.

In an eleventh aspect, there is provided a communication method performed by a terminal device. The method comprises: selecting at least one time period from a plurality of time periods based on a property of a transmission of information of the terminal device to a communication device; and transmitting to the communication device the information of the terminal device during the at least one time period.

In a twelfth aspect, there is provided a communication method performed by a communication device. The method comprises: receiving, from a terminal device, information of the terminal device during at least one time period of a plurality of time periods, and wherein the at least one time period is selected from the plurality of time periods based on a property of the transmission of the information.

In a thirteenth aspect, there is provided a computer readable medium having instructions stored thereon, the instructions, when executed on at least one processor, causing the at least one processor to carry out the method according to the first, second, third, fourth, fifth, or sixth aspect.

Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIG. 1 illustrates an example communication environment in which example embodiments of the present disclosure can be implemented;

FIG. 2 illustrates a signaling flow of contention based random access of devices to a node in accordance with some embodiments of the present disclosure;

FIG. 3 illustrates a schematic timing diagram of queries and responses in accordance with some embodiments of the present disclosure;

FIG. 4 illustrates another schematic timing diagram of queries and responses in accordance with some embodiments of the present disclosure;

FIG. 5 illustrates a further schematic timing diagram of queries and responses in accordance with some embodiments of the present disclosure;

FIG. 6 illustrates a signaling flow of contention free random access of devices to a node in accordance with some embodiments of the present disclosure;

FIG. 7 illustrates a signaling flow of time period selection in accordance with some embodiments of the present disclosure;

FIG. 8 illustrates a flowchart of a method implemented at a communication device according to some example embodiments of the present disclosure;

FIG. 9 illustrates a flowchart of a method implemented at a terminal device according to some example embodiments of the present disclosure;

FIG. 10 illustrates a flowchart of a method implemented at a terminal device according to some example embodiments of the present disclosure;

FIG. 11 illustrates a flowchart of a method implemented at a communication device according to some example embodiments of the present disclosure;

FIG. 12 illustrates a flowchart of a method implemented at a terminal device according to some example embodiments of the present disclosure;

FIG. 13 illustrates a flowchart of a method implemented at a communication device according to some example embodiments of the present disclosure;

FIG. 14 illustrates a simplified block diagram of an apparatus that is suitable for implementing example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, devices on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g., FR1 (e.g., 450 MHz to 6000 MHz), FR2 (e.g., 24.25GHz to 52.6GHz), frequency band larger than 100 GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g., signal generator, signal analyzer, spectrum analyzer, network analyzer, test terminal device, test network device, channel emulator. In some embodiments, the terminal device may be connected with a first network device and a second network device. One of the first network device and the second network device may be a master node and the other one may be a secondary node. The first network device and the second network device may use different radio access technologies (RATs). In some embodiments, the first network device may be a first RAT device and the second network device may be a second RAT device. In some embodiments, the first RAT device is eNB and the second RAT device is gNB. Information related with different RATs may be transmitted to the terminal device from at least one of the first network device or the second network device. In some embodiments, first information may be transmitted to the terminal device from the first network device and second information may be transmitted to the terminal device from the second network device directly or via the first network device. In some embodiments, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

As used herein, the term “resource,” “transmission resource,” “uplink resource,” or “downlink resource” may refer to any resource for performing a communication, such as a resource in time domain, a resource in frequency domain, a resource in space domain, a resource in code domain, or any other resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

As used herein, the term “command” or “query command” may be also referred to as “request”, “indication” or any suitable term.

As used herein, the term “time period” may be a period of time with any suitable length. The time period may be also referred to as “time slot”, “time interval” or “time frame”, or “period” for short.

### Example Environment and Working Principle

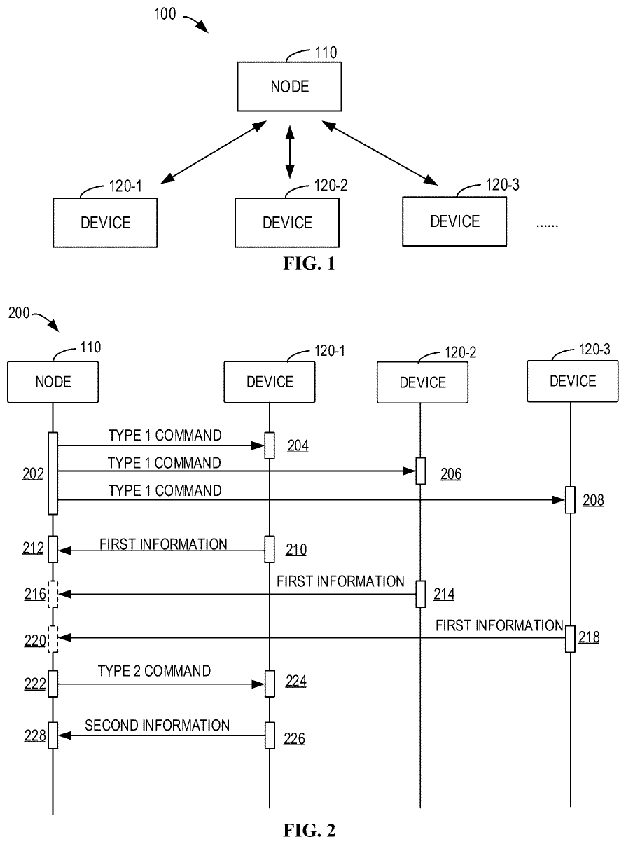

FIG. 1 illustrates a schematic diagram of an example communication environment 100 in which example embodiments of the present disclosure can be implemented. The communication environment 100 includes a node 110, and a device 120-1, a device 120-3, a device 120-3, which are individually referred to as a device 120 or collectively referred to as devices 120. It is to be understood that the number of devices as shown is an example without any limitation. In embodiments of the present disclosure, there may be more or less devices.

The device 120 may be also referred to as a terminal device. In some embodiments, the device 120 may be a battery-less device or a device with limited energy storage capability. The energy may be provided through the harvesting of radio waves, light, motion, heat, or any other power source that could be seen suitable. For example, the device 120 may be an A-IoT device.

The device may have any suitable type in terms of energy storage, energy harvesting and signal generation. In some embodiments, the device 110 may have no energy storage, no harvesting ambient sources, no independent signal generation, which means backscattering transmission is performed. In some embodiments, the device 110 may have energy storage from harvesting ambient sources, but no independent signal generation, which means backscattering transmission is performed. In such embodiments, use of stored energy can include amplification for reflected signals. In some embodiments, the device 110 may have energy storage from harvesting ambient sources, and have independent signal generation, which means active RF component for transmission.

In terms of energy storage, the device 120 may have any suitable level. In an example, the device 120 may have no energy storage at all. In another example, the device 120 may have energy storage of up to E1 joules, where E1 may be any suitable value. In a further example, the device 120 may have energy storage of up to E2 joules, where E2 may be any suitable value.

It is to be understood that the devices 120 may be of the same type or different types. Moreover, the energy storage level of the devices 120 may be the same or different.

The node 110 may be a communication device, which is capable of wireless communication. In some embodiments, the node 120 may be a network device, such as a base station, a relay, a repeater, an integrated access and backhaul (IAB) node. Alternatively, the node 110 may be a terminal device capable of radio communication, for example, UE.

Any suitable topology may be deployed in the communication environment 100. In some embodiments, a topology (1) may be deployed, and a base station (BS) may be in communication with the device 120. The topology (1) may include the possibility that a BS transmission and BS receiving is performed in different BSs. If the topology (1) is deployed, the node 110 may be one or more BSs.

In some embodiments, a topology (2) may be deployed, and a BS is in communication with an intermediate node, which is in turn in communication with the device 120. The intermediate node may include but not limited to a relay, an IAB node, a UE, a repeater, which is capable of A-IoT. If the topology (2) is deployed, the node 110 may be the intermediate node.

In some embodiments, a topology (3) may be deployed. In a link direction, a first BS is in communication with an assisting node, which is in turn in communication with the device 120. In another link direction, the device 120 is in communication with a second BS. The assisting node may include but not limited to a relay, an IAB node, a UE, a repeater, which is capable of A-IoT. The first and second BSs may be same or different. If the topology (3) is deployed, the node 110 may be the first BS and/or the second BS.

In some embodiments, a topology (4) may be deployed, and a UE may be in communication with the device 120. If the topology (4) is deployed, the node 110 may be a UE.

In some embodiments, a topology (5) may be deployed. In a link direction, a UE may be in communication with the device 120. In another link direction, the device 120 may be in communication with a BS or a UE. If the topology (5) is deployed, the node 110 may be a UE and/or a BS.

In some embodiments, for all topologies mentioned above, the device 120 may be provided with a carrier wave from other node(s) either inside or outside the topology. For all topologies, the links in each topology may be bidirectional or unidirectional.

In some embodiments, a combination of different topologies may be deployed in the communication environment 100. In some embodiments, the above-mentioned BS, UE, intermediate node, or assisting node could be multiple BSs, UEs, intermediate nodes or assisting nodes, respectively.

In some embodiments, if a BS is involved, the BS characteristic can be macro-cell based deployment, micro-cell based deployment, pico-cell base deployment, or none.

In some example embodiments, a link from the node 110 to the device 120 is referred to as a downlink (DL), while a link from the device 120 to the node 110 is referred to as an uplink (UL). In DL, the node 110 is a transmitting (TX) device (or a transmitter) and the device 120 is a receiving (RX) device (or a receiver). In UL, the device 120 is a TX device (or a transmitter) and the node 110 is a RX device (or a receiver).

The communications in the communication environment 100 may conform to any suitable standards including, but not limited to, Global System for Mobile Communications (GSM), Long Term Evolution (LTE), LTE-Evolution, LTE-Advanced (LTE-A), New Radio (NR), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

In the communication environment 100, there may be different types of traffic, for example, device-terminated traffic and device-originated traffic. The device-terminated traffic may involve device-terminated command and device-terminated reporting trigger.

For the traffic or any other suitable purpose, the node 110 may issue a query to the device 120 and the device 120 may try to respond to the query from the node 110. Such a procedure can be considered as a random access, in particular, a random access of the device 120 to the node 110.

Considering the limited size and complexity required by practical applications for batteryless devices with no energy storage capability or devices with limited energy storage that do not need to be replaced or recharged manually, the output power of energy harvester is typically from 1 μW to a few hundreds of μW. Existing cellular devices may not work well with energy harvesting due to their peak power consumption of higher than 10 mW.

An example type of application is asset identification, which presently has to resort mainly to barcode and Radio Frequency Identification (RFID) in most industries. The main advantage of these two technologies is the ultra-low complexity and small form factor of the tags. However, the limited reading range of a few meters usually requires handheld scanning which leads to labor intensive and time-consuming operations, or RFID portals/gates which leads to costly deployments. Moreover, the lack of interference management scheme results in severe interference between RFID readers and capacity problems, especially in case of dense deployment. It is hard to support large-scale network with seamless coverage for RFID.

In view of the above, the power consumption of transmission for A-IoT device could be quite small, hence the uplink transmission (from the ambient IoT device to the node that receives the signal generated by the ambient IoT device) would assume to support only time domain multiplexing (TDM) between different A-IoT devices.

As the A-IoT would support larger area and a greater number of devices than existing technology, such as RFID, for node triggered device-originated uplink transmission, collision would be happened between devices.

Embodiments of the present disclosure provide a solution to support random access of a large number of devices multiplexing in different time periods for example by two steps query. In some embodiments, a device may select a time period from a set of time periods indicated in a query command from a node and transmit its information to the node during the selected time period. Alternatively, or in addition, one or more time periods may be reserved for the device and the device may transmit its information to the node during the reserved time period. Alternatively, or in addition, a time period for a transmission may be determined based on a property of the transmission.

Principles and implementations of the present disclosure will be described in detail below with reference to the figures.

### Contention Based Random Access

In some embodiments, the node 110 may transmit one or more commands or query commands to the devices. The command is used to query information from the devices and indicates the devices 120 of a set of time periods. Each of the devices 120 may select a time period from the set of time periods and transmit its information from the selected time period. In other words, transmissions from the devices 120 may be performed based on a contention based mechanism, which is also referred to as a contention based random access merely for the purpose of discussion without any limitation.

In general, two types of command may be involved in such embodiments. A command of a first type, which is also referred to as type 1 command, is used to query first information from the devices 120. The type 1 command may be used for or correspond to type 1 query. The first information of or from a specific device 120 may include any information concerning the specific device 120, for example, a preamble, at least a part of a device identification (ID) of the specific device 120. In some embodiments, the first information may include data from the specific device 120. In some embodiments, transmission of the first information may be considered as a preamble transmission.

A command of a second type, which is also referred to as type 2 command, is used to query second information from the devices 120. The type 2 command may be used for or correspond to type 2 query. The second information of or from a specific device 120 may include any information concerning the specific device 120, for example, at least a part of a device ID of the specific device 120, data from the specific device 120, etc. In some embodiments, transmission of the second information may be considered as a message transmission. The type 1 command and type 2 command may be referred to as query command individually or collectively.

In some embodiments, a device ID of the device 120 may be transmitted in response to the type 1 query. In other words, the device ID may be included in the first information. Alternatively, or in addition, in some embodiments, the device ID of the device 120 may be transmitted in a response to the type 2 query. In other words, the device ID may be included in the second information. Alternatively, or in addition, in some embodiments, the device ID of the device 120 may be transmitted in response to the type 1 and type 2 queries. For example, a portion of the device ID may be included in the first information and the remaining portion of the device ID may be included in the second information.

Reference is made to FIG. 2, which illustrates a signaling flow 200 of a contention based random access of devices to a node in accordance with some embodiments of the present disclosure. For the purposes of discussion, the signaling flow 200 will be discussed with reference to FIG. 1.

As shown, the node 110 transmits (202), to the devices 120-1, 120-2 and 120-3, a type 1 command to schedule transmission of first information, which is also referred to as first transmission. The type 1 command, which is also referred to as first command, indicates a first set of time periods, including one or more time periods for transmission of the first information.

The devices 120-1, 120-2 and 120-3 receive (204, 206, 208) the type 1 command from the node 110, respectively. Each device 120 selects at least one time period of the first set of time periods. The time period may be selected randomly or based on a selection rule. In some embodiments, the selection rule may be associated with a property of the first transmission to be performed, as will be described with reference to FIG. 7. Different devices 120 may select the same time period or different time periods.

The devices 120-1, 120-2 and 120-3 transmit (210, 214, 218) respective first information to the node 110 during the respective selected time period. In some embodiments, two or more of the devices 120 may transmit the first information during the same time period. As a result, first information of at least one or all of the two or more devices may not be received or decoded by the node 110.

In the example of FIG. 2, the node 110 receives (212) at least the first information of the device 120-1 during the time period selected by the device 120-1. In some embodiments, the node may further receive (216) the first information of the device 120-2 during the time period selected by the device 120-2. Alternatively, or in addition, in some embodiments, the node may further receive (216) the first information of the device 120-2 during the time period selected by the device 120-3.

In response to the first information of the device 120-1, the node 110 transmits (222) a type 2 command at least to the device 120-1 to schedule transmission of second information, which is also referred to as a second transmission. The type 2 command, which is also referred to as second command, indicates a second set of time periods, including one or more time periods for transmission of the second information.

In some embodiments, the type 2 command may include information indicating which device(s) 120 shall respond to that command. For example, the type 2 command may include an identification of the time period during which the first information is received. Alternatively, or in addition, the type 2 command may include an index of a preamble included in the received first information. Alternatively, or in addition, if the first information of a device 120 includes at least a portion of the device 120, the type 2 command may include at least the portion of the device 120.

The device 120-1 receives (224) the type 2 command from the node 110. Then, the device 120-1 may select at least one time period from the second set of time periods. If the type 2 command indicates that the device 120-1 shall respond to that command, the device 120-1 may perform the time period selection. For example, if the type 2 command includes an identification of the time period during which its first information is transmitted or a preamble used by the device 120-1, the device 120-1 performs the time period selection.

The time period may be selected randomly or based on a selection rule. In some embodiments, the selection rule may be associated with a property of the second transmission to be performed, as will be described with reference to FIG. 7.

The device 120-1 then transmits (226) its second information to the node 110 during the time period selected from the second set of time periods. If there is no conflict with information from other devices, or if the node 110 is able to distinguish information from different devices, the second information of the device 120-2 is received (228) by the node 110. In this way, random access of the device 120-1 is completed.

In some embodiments, in addition to the first information of the device 120-1, first information of one or more other devices may be received during the first set of time periods. If first information of one or more other devices is received during the same time period as the first information of the device 120-1, the type 2 command is further transmitted (222) to the one or more other devices. For example, if the device 120-1 and the device 120-2 transmit the first information during the same time period, the type 2 command is further transmitted (222) to the device 120-2. In addition, in some embodiments, the time period number of the second set of time periods may be determined based on the device number of the device 120-1 and the one or more other devices. For example, a larger time period number may be determined for a larger device number. In other words, if more devices respond to the type 1 query in the same time periods, more time periods will be allocated for these devices to respond to the type 2 query. In this way, conflict possibility for these devices can be reduced.

If first information of another device is received during a time period different from the first information of the device 120-1, the node 110 may transmit to the other device another type 2 command (which is also referred to as a third command) to schedule second transmission from the other device. The third command indicates a third set of time periods different from the second set of time periods. For example, if the device 120-3 transmits (218) its first information during a time period different from the device 120-1, the node 110 may transmit the third command to the device 120-3. In this way, devices responding to type 1 query in different devices may be allocated with different time periods for responding to type 2 query.

In some embodiments, a time period of the first set of time periods is shorter than a time period of the second set of time periods. In other words, a duration of the time period for transmitting the first information may be shorter than a duration of the time period for transmitting the second information. In such embodiments, a larger number of time periods may be given to the type 1 query and a smaller number of time periods may be given to type 2 query if the detection on type 1 query indicating light load. In this way, the total time duration could be reduced.

In some embodiments, timing synchronization may not be achieved. In these embodiments, the node 110 may transmit to the devices 120 a timing command to start a time period. For example, the device 120 may start a next time period at Tₜ time length after the timing command. Alternatively, or in addition, the query command may act as a timing command. For example, the device 120 may start the first time period at T_{q} time length after the query command and start each next time period at Tₜ time length after the timing command indicating the next time period.

In some embodiments, the node 110 may terminate a time period in advance. For example, if a predetermined time length has passed since the start of a time period and no information is received from the devices 120, the node 110 may terminate the time period. Accordingly, the node 110 may transmit to the devices 120 a timing command to terminate the time period and start a next time period.

Alternatively, in some embodiments, the timing synchronization may be achieved among the devices 120. In such embodiments, the node 110 may not transmit the timing command.

In some embodiments, all type 1 queries may be performed first and then the type 2 queries. In other words, a type 2 command corresponding to the type 1 command is transmitted after the first set of time periods indicated by the type 1 command. In these embodiments, the type 2 command may include the information indicating which device(s) shall respond to the type 2 command. For example, the type 2 command may include at least one of: an identification of the time period during which the first information is received, an index of a preamble included in the received first information, or at least the portion of the device 120. Devices 120 corresponding to the information can respond to the type 2 command.

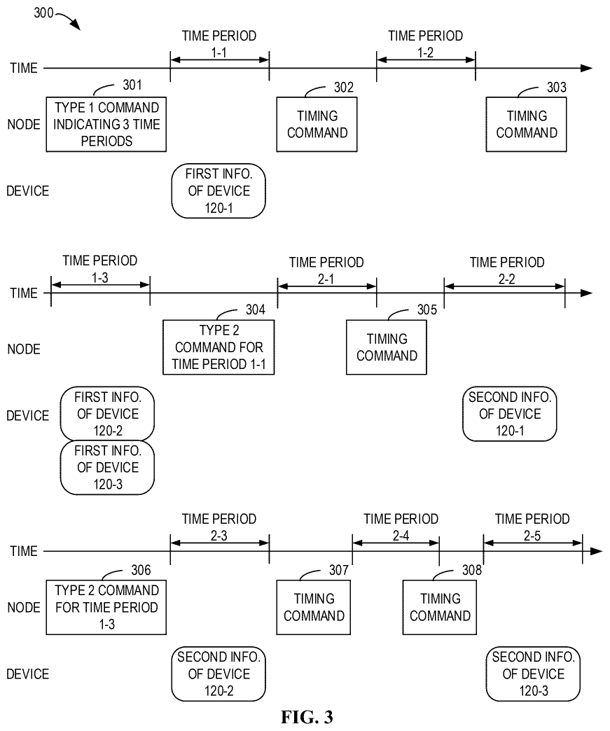

Reference is now made to the schematic timing diagram 300 as shown in FIG. 3 to illustrate example random access procedures of the devices 120. As shown, the node 110 transmits to the devices 120 a type 1 command 301 for scheduling transmission of the first information. The type 1 command 301 indicates 3 time periods, that is, a time period 1-1, a time period 1-2 and a time period 1-3. As the first time period after the type 1 command, a start of the time period 1-1 may be implicitly indicated by the type 1 command 301, as described above. The node 110 further transmits, to the devices 120, a timing command 302 indicating a start of the time period 1-2 and a timing command 303 indicating a start of the time period 1-3.

The device 120-1 receives the type 1 command 301 and selects the time period 1-1. Then, the device 120-1 transmit its first information to the node 110 during the time period 1-1. The devices 120-2 and 120-3 select the time period 1-3 and transmit their respective second information during the time period 1-3.

The first information of the device 120-1 is received by the node 110 during the time period 1-1. Accordingly, the node 110 transmits a type 2 command 304 for the time period 1-1 to schedule transmission of second information from a device which transmits the first information during the time period 1-1. The type 2 command 304 indicates 2 time periods, that is, a time period 2-1 and a time period 2-2. Since no information is received since the start of the time period 2-1, the node 110 issues a timing command 305 to terminate the time period 2-1 and to start the time period 2-2.

Each of the devices 120 receives the type 2 command 304. Since the first information of the devices 120-2 and 120-3 is not transmitted during the time period 1-1, the devices 120-2 and 120-3 will not respond to the type 2 command 304. In contrast, the device 120-1 responds to the type 2 command 304. Specifically, the device 120-1 selects the time period 2-2 and transmits its second information to the node 110 during the time period 2-2. As such, random access of the device 120-1 is completed.

Similarly, the first information of the devices 120-2 and 120-3 is received by the node 110 during the time period 1-3. Accordingly, the node 110 issues a type 2 command 306 for the time period 1-3 to schedule transmission of second information from a device which transmits the first information during the time period 1-3. The type 2 command 306 indicates 3 time periods, that is, a time period 2-3, a time period 2-4, and a time period 2-5.

As the first time period after the type 2 command 306, a start of the time period 2-3 may be implicitly indicated by the type 2 command 306, as described above. The node 110 further transmits, to the devices 120, a timing command 307 indicating a start of the time period 2-4. Since no information is received since the start of the time period 2-4, the node 110 issues a timing command 308 to terminate the time period 2-4 and to start the time period 2-5.

Each of the devices 120 receives the type 2 command 306. Since the first information of the devices 120-2 and 120-3 is transmitted during the time period 1-3, the devices 120-2 and 120-3 select at least one time period from the time periods 2-3, 2-4 and 2-5, respectively. In the example, the device 120-2 selects the time period 2-3 and transmit its second information to the node 110 during the time period 2-3. The device 120-3 selects the time period 2-5 and transmit its second information to the node 110 during the time period 2-5. As such, random access of the devices 120-2 and 120-3 is completed.

It is to be understood that the schematic timing diagram 300 is shown as an example without any limitation. Other variations may be possible. For example, in the case of timing synchronization, the timing commands may not be needed.

In such embodiments, it is benefit for the node to schedule the message transmission from the devices. The node can firstly detect all the preamble transmissions and get the load information of device access request, e.g., by power detection if the same preamble is transmitted by different devices or multi-preamble detection if the different preamble is transmitted by different devices. Then, the node can decide the number of time periods indicated in the type 2 command to get balance between contention probability and access latency.

In some embodiments, a type 2 query may be performed immediately following a type 1 query, in other words, one type 1 query and one type 2 query, and then the next one type 1 query and the next one type 2 query. In such embodiments, the type 2 command for scheduling transmission of second information from a device 120 is transmitted after the time period during which the device 120 respond to the type 1 command.

In such embodiments, the type 2 command may not include the information indicating which device(s) shall respond to that command. Therefore, the payload of the type 2 command can be reduced.

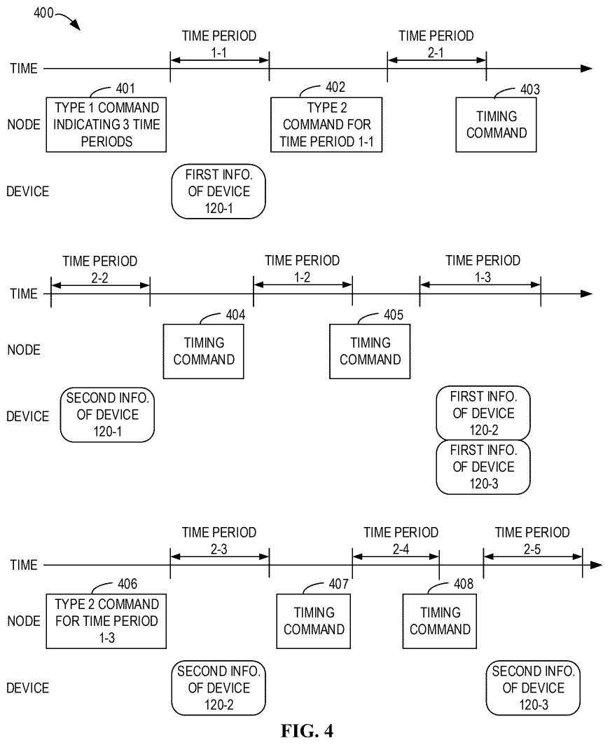

Reference is now made to the schematic timing diagram 400 as shown in FIG. 4 to illustrate example random access procedures of the devices 120. As shown, the node 110 transmits to the devices 120 a type 1 command 401 for scheduling transmission of the first information. The type 1 command 401 indicates 3 time periods, that is, a time period 1-1, a time period 1-2 and a time period 1-3. As the first time period after the type 1 command 401, a start of the time period 1-1 may be implicitly indicated by the type 1 command 401, as described above.

The devices 120-1, 120-2 and 120-3 receive the type 1 command 401 from the node 110 and select at least one time period from the time periods 1-1, 1-2, and 1-3, respectively. The device 120-1 selects the time period 1-1 and transmit its first information to the node 110 during the time period 1-1.

In response to the first information of the device 120-1, the node 110 issues a type 2 command 402 for the time period 1-1 to schedule transmission of second information from a device which transmits the first information during the time period 1-1. The type 2 command 402 indicates 2 time periods, that is, a time period 2-1 and a time period 2-2. Since no information is received since the start of the time period 2-1, the node 110 issues a timing command 403 to terminate the time period 2-1 and to start the time period 2-2.

Each of the devices 120 may receive the type 2 command 402. Since the first information of the devices 120-2 and 120-3 has not be transmitted, the devices 120-2 and 120-3 will not respond to the type 2 command 402. In contrast, the device 120-1 responds to the type 2 command 402. Specifically, the device 120-1 selects the time period 2-2 and transmits its second information to the node 110 during the time period 2-2. As such, random access of the device 120-1 is completed.

The node 110 issues a timing command 404 to start the time period 1-2. Since no information is received since the start of the time period 1-2, the node 110 issues a timing command 405 to terminate the time period 1-2 and start the time period 1-3.

Both the devices 120-2 and 120-3 select the time period 1-3 and thus transmit their respective first information to the node 110 during the time period 1-3. The first information of the devices 120-2 and 120-3 is received by the node 110 during the time period 1-3. Accordingly, the node 110 issues a type 2 command 406 for the time period 1-3 to schedule transmission of second information from a device which transmits the first information during the time period 1-3. The type 2 command 406 indicates 3 time periods, that is, a time period 2-3, a time period 2-4, and a time period 2-5.

As the first time period after the type 2 command 406, a start of the time period 2-3 may be implicitly indicated by the type 2 command 406, as described above. The node 110 further transmits, to the devices 120, a timing command 407 indicating a start of the time period 2-4. Since no information is received since the start of the time period 2-4, the node 110 issues a timing command 408 to terminate the time period 2-4 and to start the time period 2-5.

Each of the devices 120 receives the type 2 command 406. Since the first information of the devices 120-2 and 120-3 is transmitted during the time period 1-3, the devices 120-2 and 120-3 select at least one time period from the time periods 2-3, 2-4 and 2-5, respectively. In the example, the device 120-2 selects the time period 2-3 and transmit its second information to the node 110 during the time period 2-3. The device 120-3 selects the time period 2-5 and transmit its second information to the node 110 during the time period 2-5. As such, random access of the devices 120-2 and 120-3 is completed.

It is to be understood that the schematic timing diagram 400 is shown as an example without any limitation. Other variations may be possible. For example, in the case of timing synchronization, the timing commands may not be needed.

In such embodiments, the device which has responded to the type 1 query does not need to a long waiting time for the type 2 query. In this way, the energy consumption of the devices may be reduced.

Reference is made back to FIG. 2. In some embodiments, if first information of a device 120 is received by the node 110, the node 110 may transmit feedback information indicating successful receipt of the first information of that device 120. For example, if the first information of the device 120-1 is received, the feedback information may indicate the device 120-1. The feedback information may be considered as an indication of contention resolution or contention resolution information (CRI).

In some embodiments, the feedback information may be included in the type 2 command. Only the device which meets the feedback information can use the time periods indicated by the type 2 command to transmit the second information.

Alternatively, or in addition, in some embodiments, the feedback information may be included in timing command indicating a subsequent time period. A device which meets the feedback information may consider that random access is successful and waits for the type 2 command. A device which does not meet the feedback information may consider that the random access is not successful and would retransmit the first information in the left time period indicated by the current type 1 command or in a time period indicated by a next type 1 command.

Alternatively, or in addition, in some embodiments, the feedback information may be included in a command specific to the device, in other words, a dedicated command for a dedicated device 120. A device which meets the feedback information may consider that the random access is successful and respond to the dedicated command. A device which does not meet the feedback information may consider that the random access is not successful and would retransmit the first information in the left time period indicated by the current type 1 command or in a time period indicated by a next type 1 command.

In some embodiments, the node 110 may configure whether retransmission in the remaining time period(s) for the current type 1 query is allowed. For example, an indication of whether the retransmission is allowed may be transmitted along with the feedback information, for example, in the same command with the feedback information. If the retransmission in the remaining time period(s) is allowed, a device which does not meet the feedback information may select at least one time period from the remaining time period(s). Otherwise, the device may wait for a next type 1 command.

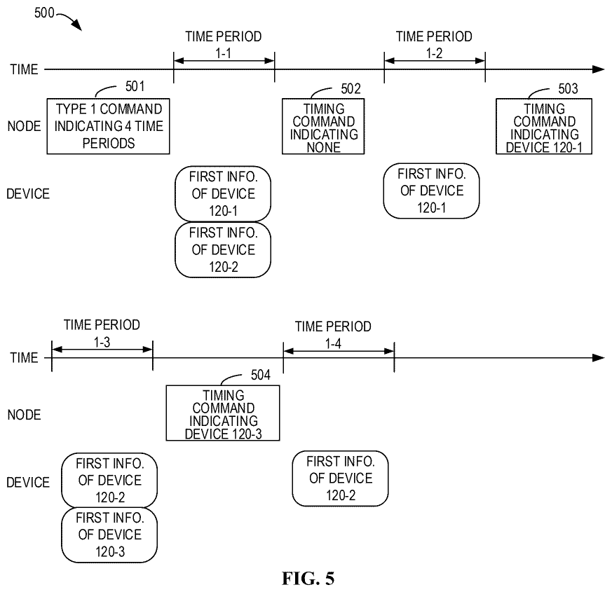

Reference is now made to the schematic timing diagram 500 as shown in FIG. 5 to illustrate example random access procedures of the devices 120. As shown, the node 110 transmits to the devices 120 a type 1 command 501 for scheduling transmission of the first information. The type 1 command 501 indicates 4 time periods, that is, a time period 1-1, a time period 1-2, a time period 1-3, and a time period 1-4. As the first time period after the type 1 command 501, a start of the time period 1-1 may be implicitly indicated by the type 1 command 501, as described above.

The devices 120-1, 120-2 and 120-3 receive the type 1 command 501 from the node 110 and select at least one time period from the time periods 1-1, 1-2, 1-3, and 1-4, respectively. The device 120-1 and the device 120-2 select the time period 1-1 and transmit their respective first information to the node 110 during the time period 1-1.

Due to the conflict of the first information from the device 120-1 and 120-2, no first information is successfully received by the node 110. Accordingly, the node 110 transmits a timing command 502 to the devices 120 to start the time period 1-2. The timing command 502 includes feedback information indicating that first information from none of the devices 120 is received.

Upon receiving the timing command 502, the device 120-1 is aware that the transmission during the time period 1-1 is unsuccessful, and thus selects a time period from the remaining time periods. Specifically, the device 120-1 selects the time period 1-2 and retransmit its first information during the time period 1-2.

The node 110 receives the first information of the device 120-1 during the time period 1-2 successfully and issues a timing command 503 indicating a start of the time period 1-3. The timing command 503 includes feedback information indicating that first information of the device 120-1 is received successfully. Upon receiving the timing command 503, the device 120-1 is aware that the retransmission during the time period 1-2 is successful.

Similar to the device 120-1, upon receiving the timing command 502, the device 120-2 is aware that the transmission during the time period 1-1 is unsuccessful, and thus selects a time period from the remaining time periods. Specifically, the device 120-2 selects the time period 1-3 and retransmit its first information during the time period 1-3.

Moreover, the device 120-3 also selects the time period 1-3 according to the type 1 command 501, and thus transmits its first information to the node 110 during the time period 1-3. As such, there is a conflict between the device 120-2 and the device 120-3 during the time period 103. The node 110 receives the first information of the device 120-3 successfully. The node 110 transmits the timing command 504 to the devices 120 to start the time period 1-4. The timing command 504 includes feedback information indicating that the first information of the device 120-3 is received successfully.

Upon receiving the timing command 504, the device 120-3 is aware that its transmission during the time period 1-3 is successful. In contrast, the device 120-2 is aware that its transmission during the time period 1-3 is unsuccessful. The device 120-3 retransmits its first information during the time period 1-4.

It is to be understood that the schematic timing diagram 500 is shown as an example without any limitation. Other variations may be possible. In the example of FIG. 5, the feedback information is included in the timing command, but can be included in any other command, request, or indication. Moreover, in the example of FIG. 5, retransmission of the first information is performed during a remaining time period for the current type 1 query. However, the retransmission may be performed during a time period for a next type 1 query, that is, a time period indicated by a next type 1 command.

### Contention Free Random Access

In some embodiments, one or more time periods may be reserved for a device 120. In other words, transmission of information from the device 120 may be performed based on a content free mechanism, which is also referred to as a contention free random access merely for the purpose of discussion without any limitation. A reserved time period may be considered as a contention free resource in time domain and thus is also referred to as a content free time period. In contrast, a time period not reserved may be referred to as a contention based time period.

In such embodiments, a device configured with a contention free time period may transmit its information during the contention free time period. Since it may be assumed that contention would not happen for the contention free time period, contention resolution may not be needed. In some embodiments, there may be a device without a contention free time period. Accordingly, the device cannot select the time period reserved for contention free transmission.

The information of the device 120 described with respect to the contention free random access may include any suitable information concerning the device 120. For example, the information may include the first information described above, or the second information described above, or a combination thereof.

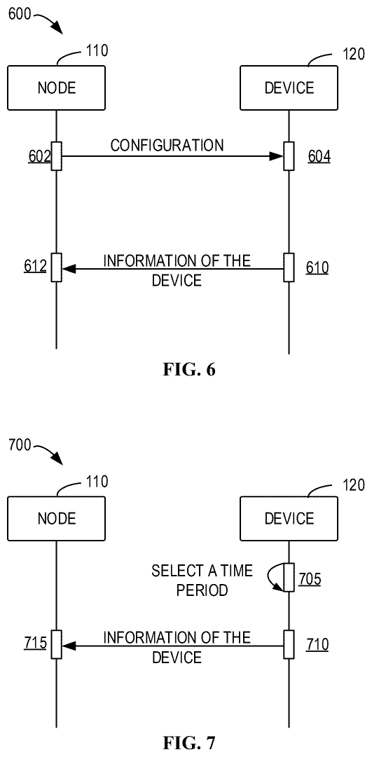

Reference is made to FIG. 6, which illustrates a signaling flow 600 of a contention free random access of devices to a node in accordance with some embodiments of the present disclosure. For the purposes of discussion, the signaling flow 600 will be discussed with reference to FIG. 1. The signaling flow 600 may involve the node 110 and the device 120, which may be any of the devices 120-1, 120-2, and 120-3.

As shown, the node 110 transmits (602) to the device 120 a configuration indicating one or more time periods reserved for transmission to the node 110. The configuration is also referred to as contention free configuration.

The contention free configuration may be included in any suitable command, request or indication from the node 110. In some embodiments, the contention free configuration may be included in a command for scheduling a transmission to the node 110, for example, the query command. Alternatively, or in addition, in some embodiments, the contention free configuration may be included in a timing command indicating a start of a time period. For example, the node 110 may indicate that a time period is reserved in a command before the time period, such as the timing command for starting that time period.

In some embodiments, the contention free configuration may be transmitted to each of the devices 120 regardless of whether a device 120 is configured with a contention free time period. Alternatively, in some embodiments, a device configured with a contention free time period may receive an indication of the contention free time period reserved for it. A device without a reserved time period may receive an indication of all the reserved time periods or an indication of time periods which it can select. In this way, the device without contention free configuration would not select the reserved time period.

The device 120 transmits (610), to the node 110, information of the device 120 during a time period determined based on the configuration. If the contention free configuration indicates that a specific time period is reserved for the device 120, the information is transmitted (610) during the reserved time period.

If the contention free configuration indicates that no time period is reserved for the device 120, the device 120 may select a time period different from the reserved time periods, and transmit the information during the selected time period. In some embodiments, if before receiving the contention free configuration the device 120 has selected a time period reserved for another device, the device 120 may select another time period. The other time period may be selected randomly among remaining time periods which are not reserved. Alternatively, the other time period may be the next unreserved time period after the previously selected time period.

The node 110 receives (612) the information of the device 120 during the time period determined based on the contention free configuration.

In such embodiments, reserved time periods for contention free random access can reduce the access latency for a delay sensitive device. For example, if a device is used for a critical traffic or time sensitive traffic, the device may be configured with one or more contention free time periods.

### Time Period Selection

Reference is made to FIG. 7, which illustrates a signaling flow 700 of time period selection in accordance with some embodiments of the present disclosure. For the purposes of discussion, the signaling flow 700 will be discussed with reference to FIG. 1. The signaling flow 700 may involve the node 110 and the device 120, which may be any of the devices 120-1, 120-2, and 120-3.

As shown, the device 120 selects (705) at least one time period (which is also referred to as target time period) from a plurality of time periods based on a property of a transmission of information of the device 120 to the node 110. The information of the device 120 may include any suitable information concerning the device 120. For example, the information may include the first information described above, or the second information described above, or a combination thereof. The plurality of time periods, which may be referred to as candidate time periods, may be indicated by the node 110. For example, the plurality of time periods may be indicated in the type 1 command or type 2 command as described above.

The property of the transmission may comprise a priority of the transmission, a rank of the transmission or a level of the transmission. Alternatively, or in addition, the property of the transmission may comprise the number of times for which the information has been transmitted, for example, an initial transmission, or a retransmission.

In some embodiments, the plurality of time periods may be divided into different priorities, ranks or levels. Taking the priorities as an example, time periods in the same set of time periods may have the same priority. The device 120 may select, from the plurality of time periods, a set of time periods with a priority corresponding to a priority of the transmission. Then, the device 120 may select the time period for the transmission from the selected set of time periods.

In some embodiments, the priority of the transmission may be determined based on a priority of the device 120. For example, if the device 120 is used for a time sensitive traffic or a critical traffic, the transmission from the device 120 may have a higher priority, as compared with another device used for a less time sensitive traffic or a non-critical traffic. Alternatively, or in addition, in some embodiments, the priority of the transmission may be determined based on the number of times for which the information has been transmitted. For example, an initial transmission may have a lower priority than a retransmission. For another example, after a certain number of retransmissions of the information, the device 120 may increase the priority of the transmission to be performed.

In some embodiments, the device 120 may select (705) the target time period from the plurality of time periods with unequal probability. Specifically, the plurality of time periods comprises a plurality sets of time periods. The device 120 may determine respective probabilities for the plurality sets of time periods based on the property of the transmission, and select the target time period from the plurality sets of time periods based on the respective probabilities.

In an example, the plurality of time periods may include a first set of time periods and a second set of time periods. For an initial transmission, the first set of time periods may have a low probability to be selected and the second set of time periods may have a probability to be selected. While for a retransmission based on some condition, the first set of time periods are may have a high probability to be selected and the second set of time periods may have a low probability to be selected.

In some embodiments, a target number of the target time periods may be determined based on the property of the transmission to be performed. The device 120 may select, from the plurality of time periods, a set of time periods with the target number as the target time periods. For example, the target number determined for a transmission with a higher priority may be larger than the target number determine for a transmission with a lower priority.

In some embodiments, a first number of time periods may be selected for an initial transmission and for a retransmission based on some condition, a second number of time periods may be selected. The second number may be larger than the first number. As such, more access success rate could be expected for retransmission.

Continuing with the signaling flow 700, the device 120 transmits (710) its information to the node 110 during the target time period. The node 110 receives (715) the information of the device 120 accordingly.

In the embodiments described with reference to FIG. 7, a higher access success rate may be allowed for some specific transmissions. For example, a higher access success rate may be allowed for the retransmission than the initial transmission. For another example, a higher access success rate may be allowed for a transmission from a device used for a time sensitive traffic than a transmission from a device used for a less time sensitive traffic.

Example embodiments for contention based random access, contention free random access, and the time period selection during random access are described above with reference to the signaling flows 200, 600 and 700, respectively. In some embodiments, embodiments described with reference to two or more of the signaling flows 200, 600 and 700 may be combined.

### Example Methods and Devices

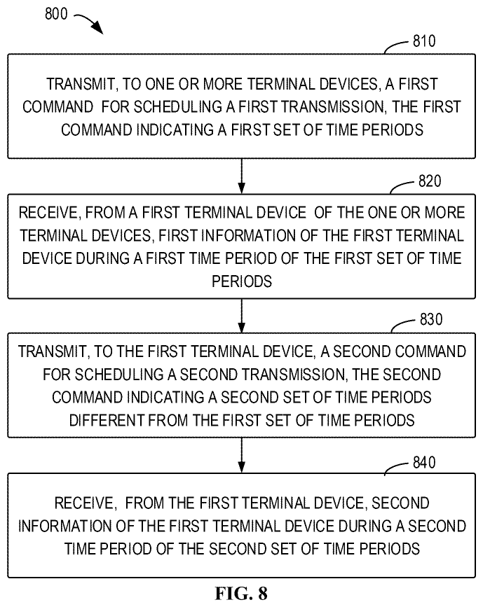

FIG. 8 illustrates a flowchart of a communication method 800 implemented at a communication device in accordance with some embodiments of the present disclosure.

For the purpose of discussion, the method 800 will be described from the perspective of a communication device, for example, the node 110 in FIG. 1.

At block 810, the communication device transmits, to one or more terminal devices, a first command for scheduling a first transmission, the first command indicating a first set of time periods.

At block 820, the communication device receives, from a first terminal device of the one or more terminal devices, first information of the first terminal device during a first time period of the first set of time periods.

At block 830, the communication device transmits, to the first terminal device, a second command for scheduling a second transmission, the second command indicating a second set of time periods different from the first set of time periods.

At block 840, the communication device receives, from the first terminal device, second information of the first terminal device during a second time period of the second set of time periods.

In some example embodiments, the second command is transmitted after the first set of time periods.

In some example embodiments, the second command comprises at least one of: an identification of the first time period, an index of a preamble in the first information of the first terminal device, or an identification of the first terminal device.

In some example embodiments, the second command is transmitted immediately after the first time period.

In some example embodiments, the communication device may receive, from at least one second terminal device of the one or more terminal devices, respective first information of the at least one second terminal device during the first time period; and determine the second set of time periods based on the number of the first terminal device and the at least one second terminal device.

In some example embodiments, the communication device may receive, from a third terminal device of the one or more terminal devices, first information of the third terminal device during a third time period of the first set of time periods; and transmit, to the third terminal device, a third command for scheduling the second transmission, the third command indicating a third set of time periods, wherein the third set of time periods are different from the first set and second set of time periods.

In some example embodiments, the communication device may in response to that no information is received since a fourth time period of the first set of time periods or the second set of time periods starts, transmit, to the one or more terminal devices during the fourth time period, a timing command to terminate the fourth time period and start a time period next to the fifth time period.

In some example embodiments, a time period of the first set of time periods is shorter than a time period of the second set of time periods.

In some example embodiments, the communication device may transmit, to the first terminal device, feedback information indicating successful receipt of the first information of the first terminal device.

In some example embodiments, the feedback information is comprised in at least one of: the second command, a timing command indicating a subsequent time period, or a command specific to the first terminal device.

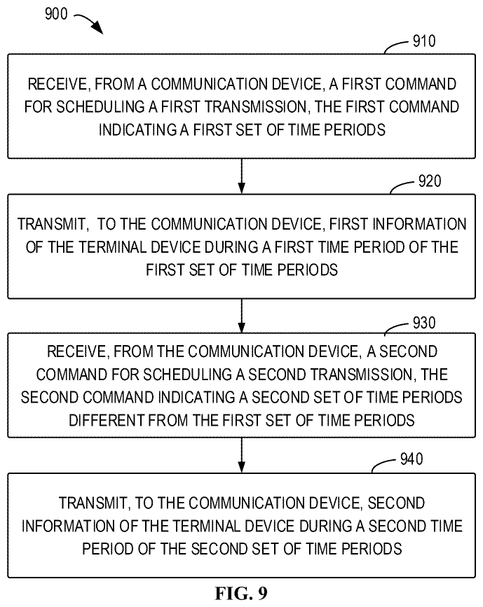

FIG. 9 illustrates a flowchart of a communication method 900 implemented at a terminal device in accordance with some embodiments of the present disclosure. For the purpose of discussion, the method 900 will be described from the perspective of a terminal device, for example, any of the devices 120-1, 120-2, and 120-3 in FIG. 1.

At block 910, the terminal device receives, from a communication device, a first command for scheduling a first transmission, the first command indicating a first set of time periods.

At block 920, the terminal device transmits, to the communication device, first information of the terminal device during a first time period of the first set of time periods.

At block 930, the terminal device receives, from the communication device, a second command for scheduling a second transmission, the second command indicating a second set of time periods different from the first set of time periods.

At block 940, the terminal device transmits, to the communication device, second information of the terminal device during a second time period of the second set of time periods.

In some example embodiments, the second command is received after the first set of time periods.

In some example embodiments, the second command comprises at least one of: an identification of the first time period, an index of a preamble in the first information of the terminal device, or an identification of the terminal device.

In some example embodiments, the second command is received immediately after the first time period.

In some example embodiments, the terminal device may receive, from the communication device and during a fourth time period of the first set of time periods or the second set of time periods, a timing command to terminate the fourth time period and start a time period next to the fifth time period, wherein the timing command is in response to that no information is received by the communication device since the fourth time period starts.

In some example embodiments, a time period of the first set of time periods is shorter than a time period of the second set of time periods.

In some example embodiments, the terminal device may receive, from the communication device, first feedback information indicating successful receipt of the first information of the terminal device.

In some example embodiments, the first feedback information is comprised in at least one of: the second command, a timing command indicating a subsequent time period, or a command specific to the first terminal device.

In some example embodiments, the terminal device may transmit, to the communication device, the first information of the terminal device during a fifth time period; receive, from the communication device, second feedback information indicating successful receipt of first information of zero or more terminal devices; in accordance with a determination that the second feedback information does not indicate the successful receipt of the first information of the terminal device, retransmit, to the communication device, the first information of the first terminal device during the first time period.

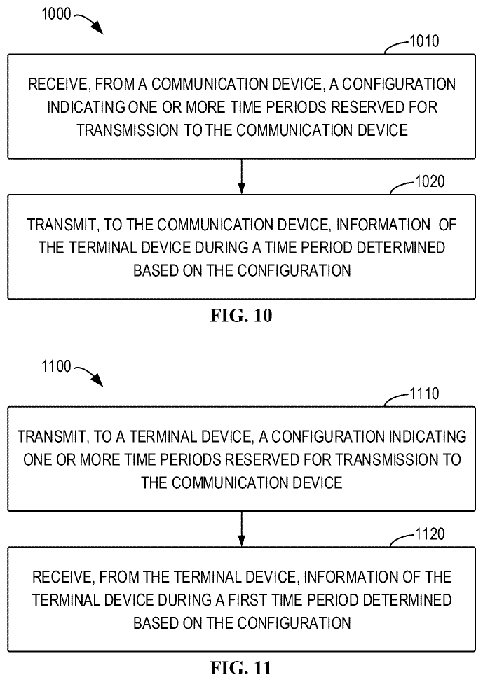

FIG. 10 illustrates a flowchart of a communication method 1000 implemented at a terminal device in accordance with some embodiments of the present disclosure. For the purpose of discussion, the method 1000 will be described from the perspective of a terminal device, for example, any of the devices 120-1, 120-2, and 120-3 in FIG. 1.

At block 1010, the terminal device receives, from a communication device, a configuration indicating one or more time periods reserved for transmission to the communication device.

At block 1020, the terminal device transmits, to the communication device, information of the terminal device during a time period determined based on the configuration.

In some example embodiments, a first time period of the one or more time periods is reserved for the terminal device, and the information of the terminal device is transmitted during the first time period.

In some example embodiments, none of the one or more time periods is reserved for the terminal device, and the information of the terminal device is transmitted during a second time period different from the one or more time periods.

In some example embodiments, the configuration is comprised in at least one of: a command for scheduling the transmission to the communication device, or a command indicating a start of the one or more time periods.

FIG. 11 illustrates a flowchart of a communication method 1100 implemented at a communication device in accordance with some embodiments of the present disclosure. For the purpose of discussion, the method 1100 will be described from the perspective of a communication device, for example, the node 110 in FIG. 1.

At block 1110, the communication device transmits, to a terminal device, a configuration indicating one or more time periods reserved for transmission to the communication device.

At block 1120, the communication device receives, from the terminal device, information of the terminal device during a first time period determined based on the configuration.

In some example embodiments, a first time period of the one or more time periods is reserved for the terminal device, and the information of the terminal device is received during the first time period.

In some example embodiments, none of the one or more time periods is reserved for the terminal device, and the information of the terminal device is received during a second time period different from the one or more time periods.

In some example embodiments, the configuration is comprised in at least one of: a command for scheduling the transmission to the communication device, or a command indicating a start of the one or more time periods.

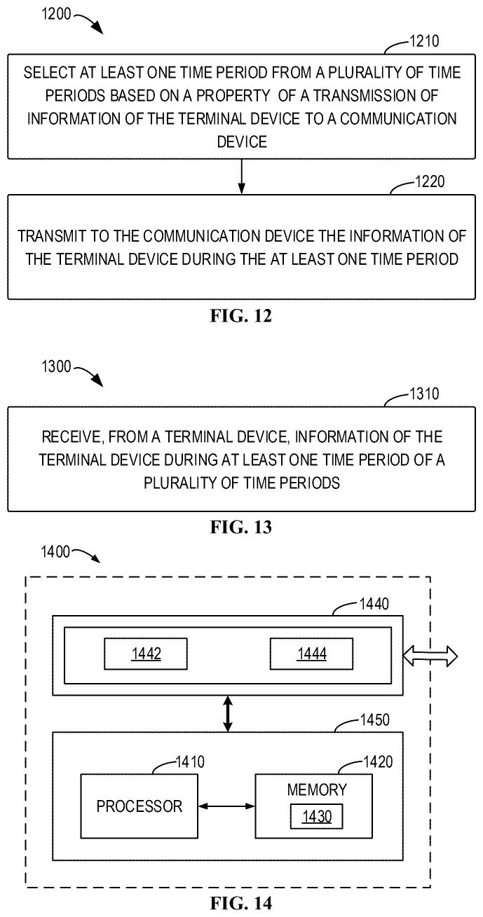

FIG. 12 illustrates a flowchart of a communication method 1200 implemented at a terminal device comprising: in accordance with some embodiments of the present disclosure. For the purpose of discussion, the method 1200 will be described from the perspective of a terminal device, for example, any of the devices 120-1, 120-2, and 120-3 in FIG. 1.

At block 1210, the terminal device selects at least one time period from a plurality of time periods based on a property of a transmission of information of the terminal device to a communication device.

At block 1220, the terminal device transmits to the communication device the information of the terminal device during the at least one time period.

In some example embodiments, the terminal device may select, from the plurality of time periods, a set of time periods with a priority corresponding to a priority of the transmission; and select the at least one time period from the set of time periods.

In some example embodiments, the priority of the transmission is determined based on at least one of: a priority of the terminal device, or the number of times for which the information has been transmitted.

In some example embodiments, the plurality of time periods comprises a plurality sets of time periods, and the terminal device may determine respective probabilities for the plurality sets of time periods based on the property of the transmission; and select the at least one time period from the plurality sets of time periods based on the respective probabilities.

In some example embodiments, a first probability for a first set of time periods determined for an initial transmission of the information is lower than a second probability for a second set of time periods determined for the initial transmission, and a third probability for the first set of time periods determined for a retransmission of the information is higher than a fourth probability for the second set of time periods determined for the retransmission.

In some example embodiments, the terminal device may determine a target number based on the property of the transmission; select, from the plurality of time periods, a set of time periods with the target number as the at least one time period.

In some example embodiments, the target number determined for an initial transmission of the information is smaller than the target number determined for a retransmission of the information.

FIG. 13 illustrates a flowchart of a communication method 1300 implemented at a communication device in accordance with some embodiments of the present disclosure. For the purpose of discussion, the method 1300 will be described from the perspective of the communication device, for example the node 110 in FIG. 1.

At block 1310, the communication device receives, from a terminal device, information of the terminal device during at least one time period of a plurality of time periods. The at least one time period is selected from the plurality of time periods based on a property of the transmission of the information.

FIG. 14 is a simplified block diagram of a device 1400 that is suitable for implementing embodiments of the present disclosure. The device 1400 can be considered as a further example implementation of any of the node and devices as shown in FIG. 1. Accordingly, the device 1400 can be implemented at or as at least a part of the node 110 or the device 120.

As shown, the device 1400 includes a processor 1410, a memory 1420 coupled to the processor 1410, a suitable transceiver 1440 coupled to the processor 1410, and a communication interface coupled to the transceiver 1440. The memory 1410 stores at least a part of a program 1430. The transceiver 1440 may be for bidirectional communications or a unidirectional communication based on requirements. The transceiver 1440 may include at least one of a transmitter 1442 and a receiver 1444. The transmitter 1442 and the receiver 1444 may be functional modules or physical entities. The transceiver 1440 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, SI/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 1430 is assumed to include program instructions that, when executed by the associated processor 1410, enable the device 1400 to operate in accordance with the embodiments of the present disclosure, as discussed herein with reference to FIGS. 1 to 13. The embodiments herein may be implemented by computer software executable by the processor 1410 of the device 1400, or by hardware, or by a combination of software and hardware. The processor 1410 may be configured to implement various embodiments of the present disclosure. Furthermore, a combination of the processor 1410 and memory 1420 may form processing means 1450 adapted to implement various embodiments of the present disclosure.

The memory 1420 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1420 is shown in the device 1400, there may be several physically distinct memory modules in the device 1400. The processor 1410 may be of any type suitable to the local technical network, and may include one or more of general purpose computers, special purpose computers, microprocessors, digital signal processors (DSPs) and processors based on multicore processor architecture, as non-limiting examples. The device 1400 may have multiple processors, such as an application specific integrated circuit chip that is slaved in time to a clock which synchronizes the main processor.

According to embodiments of the present disclosure, a communication device comprising a circuitry is provided. The circuitry is configured to: transmit, to one or more terminal devices, a first command for scheduling a first transmission, the first command indicating a first set of time periods; receive, from a first terminal device of the one or more terminal devices, first information of the first terminal device during a first time period of the first set of time periods; transmit, to the first terminal device, a second command for scheduling a second transmission, the second command indicating a second set of time periods different from the first set of time periods; and receive, from the first terminal device, second information of the first terminal device during a second time period of the second set of time periods. According to embodiments of the present disclosure, the circuitry may be configured to perform any method implemented by the communication device as discussed above.

According to embodiments of the present disclosure, a terminal device comprising a circuitry is provided. The circuitry is configured to: receive, from a communication device, a first command for scheduling a first transmission, the first command indicating a first set of time periods; transmit, to the communication device, first information of the terminal device during a first time period of the first set of time periods; receive, from the communication device, a second command for scheduling a second transmission, the second command indicating a second set of time periods different from the first set of time periods; and transmit, to the communication device, second information of the terminal device during a second time period of the second set of time periods. According to embodiments of the present disclosure, the circuitry may be configured to perform any method implemented by the terminal device as discussed above.

According to embodiments of the present disclosure, a terminal device comprising a circuitry is provided. The circuitry is configured to: receive, from a communication device, a configuration indicating one or more time periods reserved for transmission to the communication device; and transmit, to the communication device, information of the terminal device during a time period determined based on the configuration. According to embodiments of the present disclosure, the circuitry may be configured to perform any method implemented by the terminal device as discussed above.

According to embodiments of the present disclosure, a communication device comprising a circuitry is provided. The circuitry is configured to: transmit, to a terminal device, a configuration indicating one or more time periods reserved for transmission to the communication device; and receive, from the terminal device, information of the terminal device during a first time period determined based on the configuration. According to embodiments of the present disclosure, the circuitry may be configured to perform any method implemented by the communication device as discussed above.

According to embodiments of the present disclosure, a terminal device comprising a circuitry is provided. The circuitry is configured to: select a time period from a plurality of time periods based on a property of a transmission of information of the terminal device to a communication device; and transmit to the communication device the information of the terminal device during the selected time period. According to embodiments of the present disclosure, the circuitry may be configured to perform any method implemented by the terminal device as discussed above.

According to embodiments of the present disclosure, a communication device comprising a circuitry is provided. The circuitry is configured to: receive, from a terminal device, information of the terminal device during a time period of a plurality of time periods, and wherein the time period is selected from the plurality of time periods based on a property of the transmission of the information. According to embodiments of the present disclosure, the circuitry may be configured to perform any method implemented by the communication device as discussed above.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

In summary, embodiments of the present disclosure provide the following aspects.

In an aspect, it is proposed a communication device comprising: a processor configured to cause the communication device to: transmit, to one or more terminal devices, a first command for scheduling a first transmission, the first command indicating a first set of time periods; receive, from a first terminal device of the one or more terminal devices, first information of the first terminal device during a first time period of the first set of time periods; transmit, to the first terminal device, a second command for scheduling a second transmission, the second command indicating a second set of time periods different from the first set of time periods; and receive, from the first terminal device, second information of the first terminal device during a second time period of the second set of time periods.

In some embodiments, the second command is transmitted after the first set of time periods.

In some embodiments, the second command comprises at least one of: an identification of the first time period, an index of a preamble in the first information of the first terminal device, or an identification of the first terminal device.

In some embodiments, the second command is transmitted immediately after the first time period.

In some embodiments, the processor is further configured to cause the communication device to: receive, from at least one second terminal device of the one or more terminal devices, respective first information of the at least one second terminal device during the first time period; and determine the second set of time periods based on the number of the first terminal device and the at least one second terminal device.

In some embodiments, the processor is further configured to cause the communication device to: receive, from a third terminal device of the one or more terminal devices, first information of the third terminal device during a third time period of the first set of time periods; and transmit, to the third terminal device, a third command for scheduling the second transmission, the third command indicating a third set of time periods, wherein the third set of time periods are different from the first set and second set of time periods.

In some embodiments, the processor is further configured to cause the communication device to: in response to that no information is received since a fourth time period of the first set of time periods or the second set of time periods starts, transmit, to the one or more terminal devices during the fourth time period, a timing command to terminate the fourth time period and start a time period next to the fifth time period.

In some embodiments, a time period of the first set of time periods is shorter than a time period of the second set of time periods.

In some embodiments, the processor is further configured to cause the communication device to: transmit, to the first terminal device, feedback information indicating successful receipt of the first information of the first terminal device.

In some embodiments, the feedback information is comprised in at least one of: the second command, a timing command indicating a subsequent time period, or a command specific to the first terminal device.

In an aspect, it is proposed a terminal device comprising: a processor configured to cause the terminal device to: receive, from a communication device, a first command for scheduling a first transmission, the first command indicating a first set of time periods; transmit, to the communication device, first information of the terminal device during a first time period of the first set of time periods; receive, from the communication device, a second command for scheduling a second transmission, the second command indicating a second set of time periods different from the first set of time periods; and transmit, to the communication device, second information of the terminal device during a second time period of the second set of time periods.

In some embodiments, the second command is received after the first set of time periods.

In some embodiments, the second command comprises at least one of: an identification of the first time period, an index of a preamble in the first information of the terminal device, or an identification of the terminal device.

In some embodiments, the second command is received immediately after the first time period.

In some embodiments, the processor is further configured to cause the terminal device to: receive, from the communication device and during a fourth time period of the first set of time periods or the second set of time periods, a timing command to terminate the fourth time period and start a time period next to the fifth time period, wherein the timing command is in response to that no information is received by the communication device since the fourth time period starts.

In some embodiments, a time period of the first set of time periods is shorter than a time period of the second set of time periods.

In some embodiments, the processor is further configured to cause the terminal device to: receive, from the communication device, first feedback information indicating successful receipt of the first information of the terminal device.

In some embodiments, the first feedback information is comprised in at least one of: the second command, a timing command indicating a subsequent time period, or a command specific to the first terminal device.

In some embodiments, the processor is further configured to cause the terminal device to: transmit, to the communication device, the first information of the terminal device during a fifth time period; receive, from the communication device, second feedback information indicating successful receipt of first information of zero or more terminal devices; in accordance with a determination that the second feedback information does not indicate the successful receipt of the first information of the terminal device, retransmit, to the communication device, the first information of the first terminal device during the first time period.

In an aspect, it is proposed a terminal device comprising: a processor configured to cause the terminal device to: receive, from a communication device, a configuration indicating one or more time periods reserved for transmission to the communication device; and transmit, to the communication device, information of the terminal device during a time period determined based on the configuration.

In some embodiments, a first time period of the one or more time periods is reserved for the terminal device, and the information of the terminal device is transmitted during the first time period.

In some embodiments, none of the one or more time periods is reserved for the terminal device, and the information of the terminal device is transmitted during a second time period different from the one or more time periods.

In some embodiments, the configuration is comprised in at least one of: a command for scheduling the transmission to the communication device, or a command indicating a start of the one or more time periods.

In an aspect, it is proposed a communication device comprising: a processor configured to cause the communication device to: transmit, to a terminal device, a configuration indicating one or more time periods reserved for transmission to the communication device; and receive, from the terminal device, information of the terminal device during a first time period determined based on the configuration.

In some embodiments, a first time period of the one or more time periods is reserved for the terminal device, and the information of the terminal device is received during the first time period.

In some embodiments, none of the one or more time periods is reserved for the terminal device, and the information of the terminal device is received during a second time period different from the one or more time periods.

In some embodiments, the configuration is comprised in at least one of: a command for scheduling the transmission to the communication device, or a command indicating a start of the one or more time periods.

In an aspect, it is proposed a terminal device comprising: a processor configured to cause the terminal device to: select at least one time period from a plurality of time periods based on a property of a transmission of information of the terminal device to a communication device; and transmit to the communication device the information of the terminal device during the selected time period.

In some embodiments, the processor is further configured to cause the terminal device to: select, from the plurality of time periods, a set of time periods with a priority corresponding to a priority of the transmission; and select the at least one time period from the set of time periods.

In some embodiments, the priority of the transmission is determined based on at least one of: a priority of the terminal device, or the number of times for which the information has been transmitted.

In some embodiments, the plurality of time periods comprises a plurality sets of time periods, and the processor is further configured to cause the terminal device to: determine respective probabilities for the plurality sets of time periods based on the property of the transmission; and select the at least one time period from the plurality sets of time periods based on the respective probabilities.

In some embodiments, a first probability for a first set of time periods determined for an initial transmission of the information is lower than a second probability for a second set of time periods determined for the initial transmission, and a third probability for the first set of time periods determined for a retransmission of the information is higher than a fourth probability for the second set of time periods determined for the retransmission.

In some embodiments, the processor is further configured to cause the terminal device to: determine a target number based on the property of the transmission; and select, from the plurality of time periods, a set of time periods with the target number as the at least one time period.

In some embodiments, the target number determined for an initial transmission of the information is smaller than the target number determined for a retransmission of the information.

In an aspect, it is proposed a communication device comprising: a processor configured to cause the communication device to: receive, from a terminal device, information of the terminal device during at least one time period of a plurality of time periods, and wherein the at least one time period is selected from the plurality of time periods based on a property of the transmission of the information.

In an aspect, a computer readable medium having instructions stored thereon, the instructions, when executed on at least one processor, causing the at least one processor to perform the method implemented by the communication device discussed above.

In an aspect, a computer readable medium having instructions stored thereon, the instructions, when executed on at least one processor, causing the at least one processor to perform the method implemented by the terminal device discussed above.

In an aspect, a computer program comprising instructions, the instructions, when executed on at least one processor, causing the at least one processor to perform the method implemented by the communication device discussed above.

In an aspect, a computer program comprising instructions, the instructions, when executed on at least one processor, causing the at least one processor to perform the method implemented by the terminal device discussed above.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1 to 14. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A communication device comprising:
a processor configured to cause the communication device to:
transmit, to one or more terminal devices, a first command for scheduling a first transmission, the first command indicating a first set of time periods;
receive, from a first terminal device of the one or more terminal devices, first information of the first terminal device during a first time period of the first set of time periods;
transmit, to the first terminal device, a second command for scheduling a second transmission, the second command indicating a second set of time periods different from the first set of time periods; and
receive, from the first terminal device, second information of the first terminal device during a second time period of the second set of time periods.

2. A terminal device comprising:
a processor configured to cause the terminal device to:
receive, from a communication device, a first command for scheduling a first transmission, the first command indicating a first set of time periods;
transmit, to the communication device, first information of the terminal device during a first time period of the first set of time periods;
receive, from the communication device, a second command for scheduling a second transmission, the second command indicating a second set of time periods different from the first set of time periods; and
transmit, to the communication device, second information of the terminal device during a second time period of the second set of time periods.

3. The terminal device of claim 2, wherein the second command is received after the set of time periods.

4. The terminal device of claim 3, wherein the second command comprises at least one of:
an identification of the first time period,
an index of a preamble in the first information of the terminal device, or
an identification of the terminal device.

5. The terminal device of claim 2, wherein the processor is further configured to cause the terminal device to:
receive, from the communication device and during a fourth time period of the first set of time periods or the second set of time periods, a timing command to terminate the fourth time period and start a time period next to the fifth time period,
wherein the timing command is in response to that no information is received by the communication device since the fourth time period starts.

6. The terminal device of claim 2, wherein a time period of the first set of time periods is shorter than a time period of the second set of time periods.

7. The terminal device of claim 2, wherein the processor is further configured to cause the terminal device to:
receive, from the communication device, first feedback information indicating successful receipt of the first information of the terminal device.

8. The terminal device of claim 2, wherein the processor is further configured to cause the terminal device to:
transmit, to the communication device, the first information of the terminal device during a fifth time period;
receive, from the communication device, second feedback information indicating successful receipt of first information of zero or more terminal devices;
in accordance with a determination that the second feedback information does not indicate the successful receipt of the first information of the terminal device, retransmit, to the communication device, the first information of the first terminal device during the first time period.

9. A terminal device comprising:
a processor configured to cause the terminal device to:
receive, from a communication device, a configuration indicating one or more time periods reserved for transmission to the communication device; and
transmit, to the communication device, information of the terminal device during a time period determined based on the configuration.

10. The terminal device of claim 9, wherein a first time period of the one or more time periods is reserved for the terminal device, and the information of the terminal device is transmitted during the first time period.

11. The terminal device of claim 9, wherein the configuration is comprised in at least one of:
a command for scheduling the transmission to the communication device, or
a command indicating a start of the one or more time periods.

12. A communication device comprising:
a processor configured to cause the communication device to:
transmit, to a terminal device, a configuration indicating one or more time periods reserved for transmission to the communication device; and
receive, from the terminal device, information of the terminal device during a first time period determined based on the configuration.

13. A terminal device comprising:
a processor configured to cause the terminal device to:
select at least one time period from a plurality of time periods based on a property of a transmission of information of the terminal device to a communication device; and
transmit to the communication device the information of the terminal device during the at least one time period.

14. The terminal device of claim 13, wherein the processor is further configured to cause the terminal device to:
select, from the plurality of time periods, a set of time periods with a priority corresponding to a priority of the transmission; and
select the at least one time period from the set of time periods.

15. The terminal device of claim 14, wherein the priority of the transmission is determined based on at least one of:
a priority of the terminal device, or
the number of times for which the information has been transmitted.

16. A communication device comprising:
a processor configured to cause the communication device to:
receive, from a terminal device, information of the terminal device during at least one time period of a plurality of time periods, and
wherein the at least one time period is selected from the plurality of time periods based on a property of the transmission of the information.

17. A communication method comprising:
receiving, at a terminal device from a communication device, a configuration indicating one or more time periods reserved for transmission to the communication device; and
transmitting, to the communication device, information of the terminal device during a time period determined based on the configuration.

18. A communication method comprising:
transmitting, at a communication device to a terminal device, a configuration indicating one or more time periods reserved for transmission to the communication device; and
receiving, from the terminal device, information of the terminal device during a first time period determined based on the configuration.

19. A communication method comprising:
selecting, at a terminal device, at least one time period from a plurality of time periods based on a property of a transmission of information of the terminal device to a communication device; and
transmitting to the communication device the information of the terminal device during the at least one time period.

20. A computer readable medium having instructions stored thereon, the instructions, when executed on at least one processor, causing the at least one processor to perform the method according to any of claims 17-19.
